(19) United States
(12) Patent Application Publication
(10) Pub. No.: US 2015/0294582 A1
(43) Pub. Date: Oct. 15, 2015

(54) INFORMATION COMMUNICATION TECHNOLOGY IN EDUCATION

(71) Applicant: IT School Innovation (Pty) Ltd., Faerie Glen (ZA)

(72) Inventors: Jacobus LIEBENBERG, Pretoria (ZA); Francois GELDENHUYS, Pretoria (ZA); Daniel LOWES, Pretoria (ZA); Gary PAMPARÀ, Pretoria (ZA); Morne BOTHA, Pretoria (ZA)

(73) Assignee: IT School Innovation (Pty) Ltd., Faerie Glen (ZA)

(21) Appl. No.: 14/687,460

(22) Filed: Apr. 15, 2015

Related U.S. Application Data
(60) Provisional application No. 61/979,670, filed on Apr. 15, 2014.

(51) Int. Cl. G09B 7/02; G09B 5/08; G09B 5/06

(52) U.S. Cl. CPC G09B 7/02; G09B 5/06; G09B 5/08

(57) ABSTRACT

An educational infrastructure in which an educational institution has a real or virtual computerized server that is in operative communication with communications devices accessible to multiple students who are individually identifiable by way of identification data inputted from time to time by the individual students and wherein the computerized server is programmed to monitor individual student activity on the relevant communications device whilst the student utilizes electronic learning material by way of the communications device, and wherein the computerized server is further programmed to record data as to the nature and duration of student engagement with electronic learning material of different types.

### FIELD OF THE INVENTION

This invention relates to the use and control of information communication technology in the educational field for the education of students typically with the assistance or input of facilitators.

### BACKGROUND TO THE INVENTION

The use of Information Communication Technology (ICT) is becoming an integral part of our modern-day society, from an early age onwards. Students need to be fluent in its use for learning, leisure and academic work. It is becoming an efficient medium for finding and using information as part of the learning process. It therefore appears that Information Communication Technology should advantageously be integrated with the learning curriculum of students.

It is envisaged that by utilizing an effective strategy students can be encouraged and guided to effectively utilize available Information Communication Technology resources to improve their quality of work and presentation skills across all subjects.

Such a policy can serve as a mechanism to improve current teaching methods and presentation of the subject, thereby developing Information Communication Technology skills across all age groups and subject areas in a safe and regulated environment.

Guided educational usage could focus on general computer usage; usage of network environments; usage of the Internet; usage of internet resources such as, but not limited to, chat rooms, search engines, online mail resources etc; usage of e-mail and usage and interaction with social media and social groups.

### SUMMARY OF THE INVENTION

In accordance with a first aspect of this invention there is provided an educational infrastructure in which an educational institution has a real or virtual computerized server that is in operative communication with communications devices accessible to multiple students who are individually identifiable by way of identification data inputted from time to time by the individual students and wherein the computerized server is programmed to monitor individual student activity on the relevant communications device whilst the student utilizes electronic learning material by way of the communications device, and wherein the computerized server is further programmed to record data as to the nature and duration of student engagement with electronic learning material of different types.

Further features of the invention provide for the computerized server and communications devices to operate on a cloud principle in which the computerized server retains at least the majority of software and electronic data used by the students including learning material in the form of electronic publications. The educational infrastructure may include personalization of the learning material using push technology between the server and the communications device. Such push technology enables student personalization of electronic learning material.

Further features of the invention provide for the communications devices to be wireless devices such as those known currently as “tablets”; for the individual students to be identified by way of a user name and individual password; for the activity that is monitored to include the performance of the student in one or more of frequency of note taking, frequency of highlights being made to educational content in the form of electronic learning material, frequency of exploring provided content pushed by teachers, frequency of own content added to electronic learning material such as an e-book, validity of content appended by a student related to current subject matter, quality of summaries generated by a student, frequency of opening, closing and duration of using a given electronic learning material such as a text book; and for previous assessment information to be employed to identify problem areas of study.

The educational infrastructure may include including storing student provided content and annotations to the learning material, for example, at the server, and optionally including enabling educator input from educator communication devices wherein the educator input relates to a particular student and includes input to learning material accessed by the student providing a unique student instance of the electronic learning material including student and educator content. The educator content may be provided by push notifications to the student device.

The educational infrastructure may include including monitoring student interaction with the electronic learning material, creating a student profile based on the monitored interaction; and scheduling assessments and input required based on the student profile.

The educational infrastructure may further include inserting interactive assessments in the content of an electronic learning material on the fly that become part of the electronic learning material and require no linking to external applications or websites.

The educational infrastructure may also include synchronizing all content relating to the electronic learning including as originally published, created by the student, or created by the educator, on the server and stored in the data store in real time or periodically as and when access to the server is available, thereby enabling complete recovery of content by students and educators alike in the event of device malfunction, failure or switchover.

In accordance with a second aspect of this invention there is provided an electronic publication (EPUB) summary of a full electronic publication in which a structure of the full electronic publication is extracted and added to the summary, a plurality of phrases or passages or both in text of the full electronic publication which have been highlighted are extracted and added to the summary in a manner such that an assembly of the highlighted phrases and passages, together with any other information that is required, forms a summary of the full electronic publication.

Further features of this second aspect of the invention provide for extracting highlighting to be effected in combination with the identification of the start and of the end of a phrase or passage to form a three-part tuple conveniently identifying a start character and end character and a type of highlighting; for different phrases or passages to be highlighted differently for other purposes; and for the EPUB summary to be optionally further enriched with other relevant content added to the full electronic publication selected from images, videos, Uniform Resource Locator (URL) links, and other documents that can be attached at specific elements to enrich the existing content with additional information.

In accordance with a third aspect of this invention there is provided an EPUB book in which the book is enhanced by inserting interactive assessments in the content of the book that become part of the book and require no linking to external applications or websites.

Further features of the third aspect of the invention provide for the assessments to be configured to test a student's knowledge about a section of the EPUB book; for meta-data to be attached to questions and activities; for scores to be allocated to each question in order to assess a student's knowledge about different aspects of a subject and provide a score; and for scores developed in such an operation to be sent to an educator for evaluation either immediately or at an appropriate later time.

In accordance with a fourth aspect of this invention there is provided a web-based audio-visual content creation tool comprising a student side and a server side wherein the student side is displayed in a web browser with a large blank area (“canvas”), command palettes, a screen toggle area, and control buttons, wherein the command palettes allow the student to choose operations selected from, or comprising, drawing lines, placing images, and erasing images in the blank area and wherein the data is sent to the server in pieces by the student, and then reassembled by the server before storage.

Further features of the fourth aspect of the invention provide for the screen toggle area to allow the student to create multiple virtual screens and move between them both before and during the recording; for the control buttons to allow the student to start, pause, and stop the recording at any time, as well as previewing the recording made so far, or cancelling it and starting over; for a timestamp captured with each event to be used to synchronize audio data with the video data for playback; and for the audio replay to determine the pace of the playback with video events being consumed as fast or as slow as required to keep up with the audio playback.

The web-based audio-visual content creation tool may include a format of the data which results in a small file size and allows the data to be streamed to the server directly, even on slower connections, wherein the data is chunked into segments, each of which is transcoded independently, and then sent on to the server as the recording continues resulting in by the time the recording is finished, a substantial amount of the data is already held by the server.

According to another aspect of the present invention there is provided a method for providing personalized electronic learning material in an educational infrastructure, including: providing access for a student to electronic learning material and referencing a student instance of the electronic learning material; storing student provided content additions and annotations of the student instance of the electronic learning material; pushing educator content into one or more specific student instances of the electronic learning material for storing in association with the student instance of the electronic learning material; and providing a unique student instance of the electronic learning material including student and educator content. In this way, an educator from his computing device may drop content into individual or groups of students' instances of their electronic learning material.

According to another aspect of the invention there is provided a method for monitoring a student's activity in an educational infrastructure, including: providing access for a student to electronic learning material and referencing a student instance of the electronic learning material; monitoring student interaction with the electronic learning material; creating a student profile based on the monitored interaction; and scheduling assessments and input required based on the student profile. This method may be provided as a computer-implemented method.

According to another aspect of the invention there is provided a method for monitoring a student's activity in an educational infrastructure, including: providing access for a student to electronic learning material and referencing a student instance of the electronic learning material; storing student provided content additions and annotations of the student instance of the electronic learning material; storing educator provided content additions and annotations of the student instance of the electronic learning material; and providing a unique student instance of the electronic learning material including student and educator content. This method may be provided as a computer-implemented method.

In order that the invention may be more fully understood a more detailed description thereof follows.

### BRIEF DESCRIPTION OF THE DRAWING

FIG. 1 is a schematic diagram showing an educational infrastructure on which aspects of this invention are operable;

FIG. 2 is a block diagram of example component of the educational infrastructure of FIG. 1;

FIG. 3 is a flow diagram of a method of operation of a server of the educational infrastructure of FIG. 1;

FIG. 4A is a schematic diagram of an electronic publication and summary in accordance with an aspects of the present invention;

FIG. 4B is a flow diagram of an example method of generating a summary of an electronic publication in accordance with the aspect shown in FIG. 4A;

FIG. 5A is a schematic diagram of an electronic publication in accordance with aspects of the present invention;

FIG. 5B is a flow diagram of an example method of an electronic publication in accordance with the aspect shown in FIG. 5A;

FIG. 6 is a block diagram of an example system in accordance with further aspects of the present invention; and

FIG. 7 is a block diagram of a data processing system in which aspects of the present invention may be implemented.

### DETAILED DESCRIPTION OF THE INVENTION

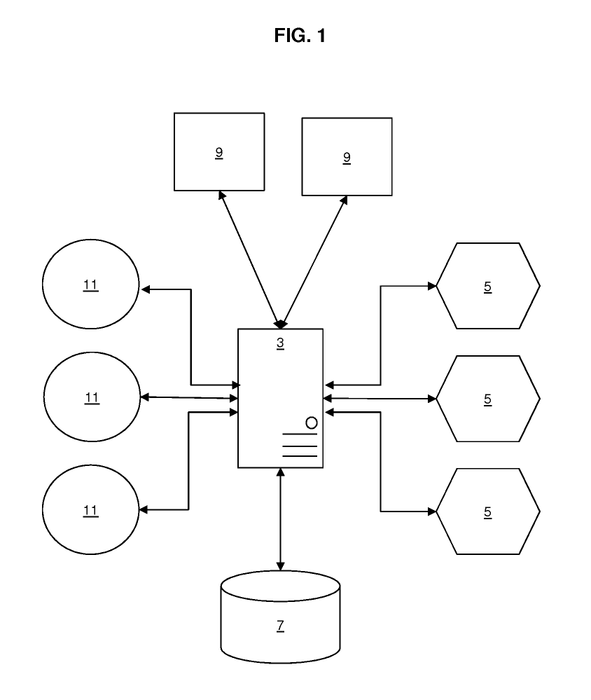

An educational infrastructure (1), as shown in FIG. 1, is provided in which an educational institution such as a school or college (not shown) has a computerized server (3) that is in operative communication with a multitude of communications devices (5) accessible to, and preferably personal to, students who are individually identifiable by the computerized server (3) by way of identification data. Identification data may include data inputted from time to time by the individual students, license data issued by the computerized server (3) and submitted to the communications devices (5) upon initialization of the devices (5) and updated from time to time, digital signatures uniquely associated with student devices (5) or individual students, or combinations or variations of the aforementioned. In the very least, the individual students may conveniently be identified by way of a user name and unique individual password.

The communications devices may take many different forms that will depend, at least to some extent, on the degree of sophistication of the educational institution and its students. It is preferred that communication between the computerized server and the communications device be wireless and it is envisaged that a preferred arrangement would be one in which the communications devices assume the form of the well-known electronic tablet.

The computerized server and communications devices preferably operate on a cloud principle in which the computerized server retains at least the majority of software and electronic data used by the students in an electronic data store (7), and a minimum amount of programming material is required on the communications device. Whilst communications could take place in any conventional manner, it is envisaged that a school's premises could be set up as a WiFi zone. It should be apparent to those skilled in the art that communication between the server and communications devices may, however, be conducted over local area, wide area or distributed networks such as the Internet, and may include a combination of wireless, wired, near-field, mobile and radio communications techniques.

In general, the server (3) is configured to provide electronic content, most notably in the form of electronic publications (EPUB) (9), which could be books published in electronic format. The EPUBs are individually licensed to individual students most commonly following an electronic purchase of the EPUB by the applicable student. Naturally, to comply with copyright and electronic licensing restrictions and regulations, EPUBs may be encrypted by the server or a provider so as to avoid onward and unauthorized distribution thereof by the student. Individual students may be provided with license keys enabling them to decrypt encrypted and downloaded EPUBs that they have purchased or are otherwise authorized to access. In this way access and distribution of the EPUBs may be controlled by the computerized server. It will be apparent that the computerized server will keep records of purchased EPUBs and their associated licensing information and keys for each individual student, thereby enabling students to switch between devices without loss of access to licensed EPUBs or built up content.

The computerized server (3) is programmed to monitor individual student activity on the relevant communications device (5) whilst the student utilizes learning material by way of the communications device. Such activity may be one or preferably all of frequency of note taking; frequency of highlights being made to educational content; frequency of exploring provided content put forward by educators; frequency of own content added to an EPUB or other book or other electronic material; validity of content appended by a student (related to current subject matter); quality of summaries generated by a student; frequency of opening, closing and duration of using a given EPUB or other text book.

The computerized server is thus programmed to record data as to the nature and duration of student engagement with learning material of different types.

The programming also preferably includes previous assessment information that may be employed to identify problem areas of study.

Statistics may be gathered on a regular basis and a profile of each student built up. This profile would be unique to each student and could be compared to that of the remainder of the grade students.

Simply by way of example, it may be detected that a particular student is studying for an upcoming test but for some reason is busy studying the wrong content in relation to the rest of the students in that grade. This is clearly a mistake and the computerized server would, either by virtue of its own programming, or on activation by an educator or other person, send a message to that student indicating that the current work is not relevant to the upcoming test.

As a student progresses through the learning material, assessments may be provided from either an educator's intervention or from the system itself. It is feasible that other topics may be sourced for the assessment, based on what the student is currently doing, so that the current work is shown to be dependent on previous work. This will make the student reinforce the knowledge from previous sections.

Additionally it should be possible to learn that a student is struggling with the understanding of a particular area of study. This information should be provided to the relevant parties so that the student may be assisted and have the misunderstanding prevented, before it results in a more dire situation developing.

The reinforcement system may be a dual system, existing both on the server infrastructure and in a reader application of the student. The systems may communicate and work together to interact with the student. The server component may be responsible for mining the data from the student and generating a student profile, together with a profile for that grade of students. From this profile, the server can schedule frequent assessments and student interaction, from which the profile of the student may be updated and maintained.

Educators are provided access to learning material, and other data stored by the server in the data store (7) from educator browsers (11), which could be dedicated systems installed at the educational institution, or web-based browsers which the educators may use to gain access to the server and stored information from any web-enabled device. Educators also have the capability to upload content to individual student profiles, interact with individual students or groups of students, create resources and attach resources to EPUBs.

It will be appreciated that all educator as well as student data, whether delivered by the server or an independent Content Delivery Network (CDN) such as an independent publisher, or created by students or educators alike, may be stored by the server in the data store. This enables all data to be entirely restorable to educator or student devices in the case of data loss on devices.

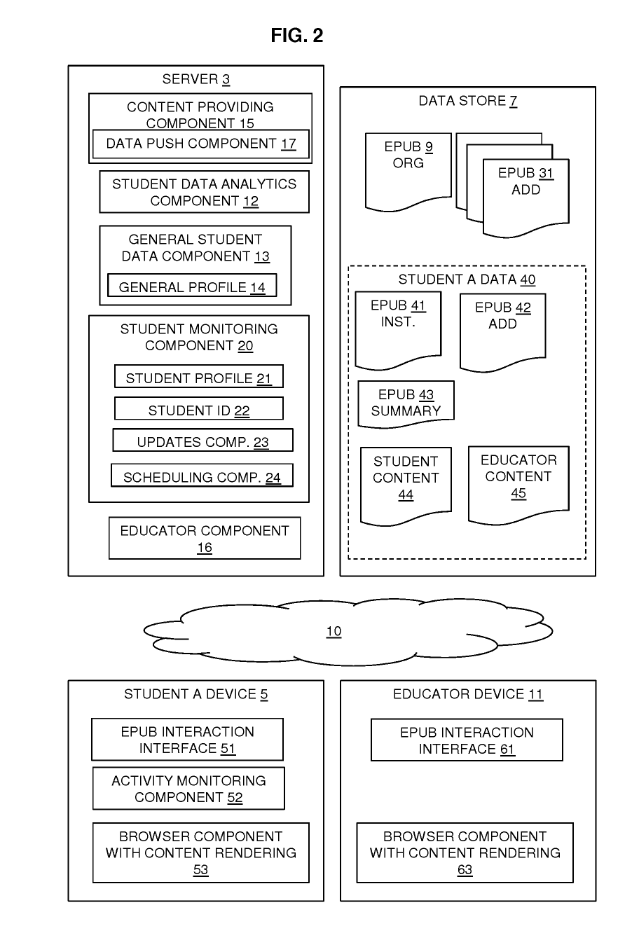

Referring to FIG. 2, a block diagram illustrates an example embodiment of components of the described educational infrastructure. A server (2) is shown with a data store (7) which may be provided locally to or remotely from the server (2). A network (10) allows communication with a student device (5) and an educator device (11). In this embodiment, a single student device (5) for student A is shown and a single educator device (11) is shown; however, it is understood that the infrastructure includes multiple student devices (5) and multiple educator devices (11).

The server (3) may include a content providing component (15) for providing electronic content in the form of EPUBs (9) as well as EPUB additional content (31) for updating the EPUBs (9) with additional content which may be provided on the fly to student users. The content providing component (15) may include a data push component (17) which uses push technology between the server (3) and student devices (5) and educator devices (11). Personalization of EPUBs (9) is an effect of pushing the personalized information to the users directly.

An instance of an EPUB (41) may accessed by a specific student and may be downloaded onto the student device (5). A downloaded instance of an EPUB (41) may be backed up to the data store (7) of the server (3) when the student device (5) is in network communication with the server (3). An instance or references to the EPUB (41) may also be stored at a data store (7) of the server (3) for a specific student such as student A (40). Other data may be stored together with the EPUB instance or reference including EPUB additional content (42) for the particular student, an EPUB summary (43) development by the student, student content (44), and educator content (45) which may be provided specifically for the particular student. The student A data (40) may be stored at the data store (7) of the server (3) remotely from the student device (5) and the educator device (11) and updates may be pushed to the student device (5) and educator device (11). The student device (5) and the educator device (11) may have browser components (53, 63) with rendering capability for the various EPUB content and associated data and push notifications.

The student device (5) may include an EPUB interaction interface (51) for annotating, reading, adding content to, and otherwise interacting with the EPUB instance (41). A student may interact with multiple EPUB instances.

The educator device (11) may also include an EPUB interaction interface (61) for interacting with an EPUB instance for a particular student, such as student A for providing educator annotations and input, or for a group of students. It is envisaged that educator input may be provided for multiple EPUB instances for a group of students, for example, students in a class, or a sub-set of a class.

An activity monitoring component (52) may be provided at the student device (5) for monitoring the student's interaction with the EPUB and a corresponding student monitoring component (20) of the server (3) may store and analyze the student interaction.

The server (3) may include a student data analytics component (12) for analyzing data relating to students from the data obtained by the student monitoring component (20). This may include data mining to extract data relating to a student. A general student data component (13) may gather and analyze data relating to a group of students, such as in a common grade or class. A general profile (14) of such a group of students may be generated for comparison purposes.

The student monitoring component (20) may include a student profile (21) for a particular student which is based on the gathered data for that student and may be compared to the general profile (14). A student identifier (22) for example with a login user name may be provided for identifying the student and monitoring their resources. An updates component (23) may be provided for updating the student profile (21) and a scheduling component (24) may be provided for scheduling assessments and also for altering an educator if required. The server (3) may also include an educator component (16) for communicating with an educator device (11).

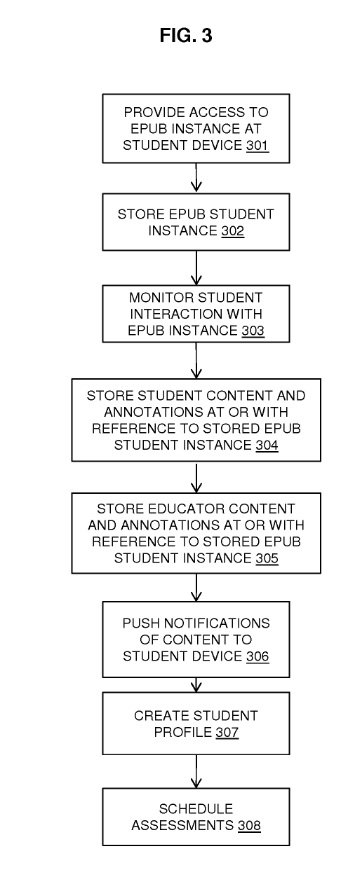

Referring to FIG. 3, a flow diagram shows an example embodiment of a method carried out at a server (3) of the described educational infrastructure.

Access to an EPUB may be provided (301) at a student device. Access by the student device may be via a browser or an application. The EPUB may be downloaded at the student device. A student's EPUB instance including additional content may be backed up and stored (302) at a data store of a server and accessed by the student device if data is lost at the student device. Content additions or annotations made to a downloaded instance may be monitored and stored by the server with push notifications sent to the student device. Multiple EPUB instances of different learning material may be provided for access by each student device.

Any interaction of the student via his device with an EPUB instance may be monitored (303). Student provided content or annotations or additions may be stored (304) at or with reference to the stored EPUB instance for that student providing an individualized version of the EPUB. In addition, educator provided content or annotations may be stored (305) at or with reference to the stored EPUB instance for that student providing a further unique, individualized version of the EPUB with personal or group feedback from an educator.

Push notifications of content, references, or annotations of an EPUB instance may be provided (306) to a student device from an educator device via the server.

The method may also include creating (307) a student profile based on their interaction and scheduling (308) assessments and feedback based on the student profile. Assessments may be pushed to the student device as additional content for an EPUB.

In one embodiment, an educator may provide content by dropping content into an EPUB at a desired location using a browser of the educator's device. The educator may provide content for a class of students, a sub-set of the class, or an individual. The content is sent by the server to the student devices of the students to which the content applies and is added to their instances of the EPUB by push notifications to their devices.

The students' instances of the EPUB including received educator content as well as their own annotations and additions are stored at their devices and also backed up to the server. The back up may be to a local server as well as to a cloud based server.

Turning now to the second aspect of this invention there are provided electronic (EPUB) books in which a plurality of phrases or passages or both in the text of the book are highlighted in a manner such that an assembly of the highlighted phrases and passages, together with any other information that is required, forms a summary of the book.

Different highlighting may be used for different purposes and different phrases or passages may be highlighted differently for such purposes. The type of highlighting could be different colored backgrounds, underlining, or anything rendering the phrases or passages clearly identifiable.

A highlight should be understood as meaning a decoration of some sort to make a phrase or passage more prominent in the text. To highlight specific phrases or passages in the document, that HTML element needs to be located. The element could be in any of the files, and anywhere in that file. To pinpoint the element, a Cascading Style Sheet (CSS) selector is used. CSS is designed primarily to enable the separation of document content from document presentation, including elements such as the layout, colors, and fonts. This separation can improve content accessibility; provide more flexibility and control in the specification of presentation characteristics; enable multiple pages to share formatting; and reduce complexity and repetition in the structural content.

Since CSS selectors only point to an HTML element that can contain yet more HTML, a third piece of information is needed to refer to an exact phrase. This may be achieved by extracting only the text content of the element referenced by the CSS selector, and then using character indexes to specify the start and end of the phrase. The result is a three-part tuple with start character, end character, and type of highlighting (decoration). That is all that is needed to describe a specific highlight in an EPUB book.

EPUB books can also be enriched with other relevant content. Resources such as images, videos, URL links, and other documents can be attached at specific elements to enrich the existing content with additional information. In much the same way as highlights are described so a specific attachment in an EPUB book may be described by the CSS selector and a link to the attached content.

To extract a summary from such an EPUB book it is assumed that the highlights made in the book indicate important areas that can be included in a summary. The summary may thus consist of all the highlighted text, and some context around the highlight. The summary may also include relevant structural information, such as chapter names and headings, to give a user more context about from where in the book specific parts were extracted. The extracted parts should be in the order in which they appear in the book.

To extract the summary, the EPUB's spine definition is used to iterate through the HTML files in order. Elements where phrases are highlighted are then extracted and placed, in the order they appear in the original pages, on to a new summary page. This new summary page will thus contain elements from all the HTML files defined in the spine of the EPUB book. Relevant structural content may also be inserted. The HTML elements that make up the content of the pages are generally small sections and paragraphs, so showing the whole element should give the necessary context for the highlight. If the book has resources that were attached to enrich the content, these are also shown at the relevant sections.

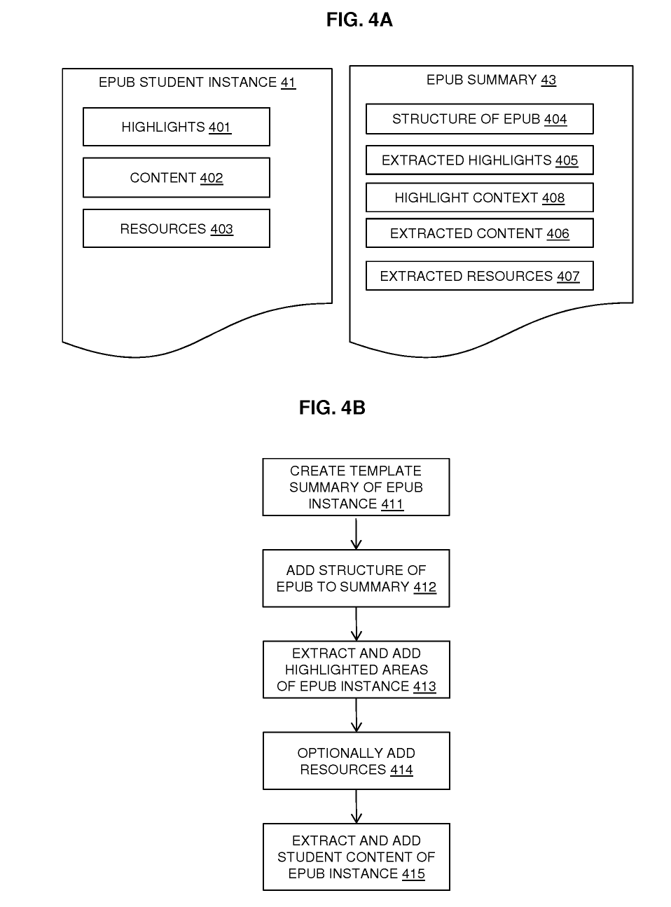

Referring to FIG. 4A, a schematic diagram shows an EPUB instance (41) of a student and a generated EPUB summary (43). The EPUB instance (41) may include student provided highlights (401), content (402) and referenced resources (403).

The EPUB summary (43) may include the structure of the EPUB (404) such as the contents and titles, extracted highlights (405) as described above together with context (408) for the highlights obtained from the EPUB instance (41). The EPUB summary (43) may also include extracted content (406) from the EPUB instance (41) and extracted resource references (407) from the EPUB instance (41).

Referring to FIG. 4B, a flow diagram shows an example embodiment of a method of providing an EPUB summary (41). The method may include creating (411) a template summary of the EPUB instance. This may include adding (412) the structure of the EPUB such as the contents and headings to the summary.

Highlights of the EPUB instance may be extracted and added (413) to the summary together with resource references (414) and other student or educator added content (415).

The third aspect of this invention provides an electronic (EPUB) book in which the book is enhanced by inserting interactive assessments in the content of the book that become part of the book and require no linking to external applications or websites. The assessments may be configured to test a student's knowledge about a section of the electronic book. Meta-data may be attached to questions and activities and scores can be allocated to each question in order to assess a student's knowledge about different aspects of a subject. Scores may be developed that are sent to an educator for immediate or later evaluation.

Assets or assessments may be created by educators or publishers and inserted into the book.

Alternatively, assets or assessments may be scripted by publishers and files may be embedded into the book's source code. It should be noted that these additional resources are generally published into the EPUB after the delivery of the EPUB to the learner. In other words, delivery of additional content to learners generally happens “on the fly” and not with the creation of the EPUB, although the latter is also possible. Delivery of additional content may be by push notification of the content to the EPUB instance of the student. Once the assets are in the book a student may access them by clicking on the relevant icon and completing the activity. When the student is done, a score may be presented to the student. This score may only reflect the overall attempt of the student and a more detailed score may be sent to the computerized server for perusal by an educator.

The assets may assume many different forms. It may require a student to choose options by presenting the student with a question and a number of possible answers. The student must choose the correct answer.

It may assume the form of a puzzle in which an image is shuffled and the student is required to correct the image by swapping pieces in say a 4×3 grid.

The asset may be a word builder in which a question is presented to the student and the answer must be built from a number of jumbled letters.

The asset may require the matching of items wherein the student must match up to four items on the left with their related items on the right. The items on the right are swapped out until the matches are correct.

The asset may require a fill in wherein a statement or equation is presented to the student with a blank block that requires completion in order to continue the assessment.

The asset may require a spelling of a word to be corrected by swapping out wrongly ordered letters.

The system allows EPUB books to be extended with additional content by students. Arbitrary additional data, either files or text, can be attached to points in the book, and then viewed inside the book itself when opened through an appropriate book renderer. The system consists of two parts: a web interface which lets students attach items to books, and a mobile device application which can render the books along with the additional content. The mobile device application is specifically designed to understand how to render the additional content in the book.

An educator may make use of a web interface which renders the book as it appears on the communications devices. The educator can drag and drop items from a variety of categories (e.g. text, images, URLs, videos, etc.) into the book. The interface indicates where the items are attached, and they can be moved around or removed using the same drag/drop functionality. The items become immediately accessible by push notifications, and users with the book open can simply click a button to receive the latest items. While only educators can add content to the book from the web interface, students can add notes and sketches of their own directly through the application. The result of the combined activity of the educator and the student is a unique EPUB which exists between the particular educator and the student since there is only one version per student which contains her/his notes, additions and sketches as well as those of the educator. This results in a personalized EPUB.

As before, it should be appreciated that all content, whether as originally published, created by the student or created by the educator, is synchronized on the server and stored in the data store in real time or periodically as and when access to the server is available, thereby enabling complete recovery of content by students and educators alike in the event of device malfunction, failure or switchover.

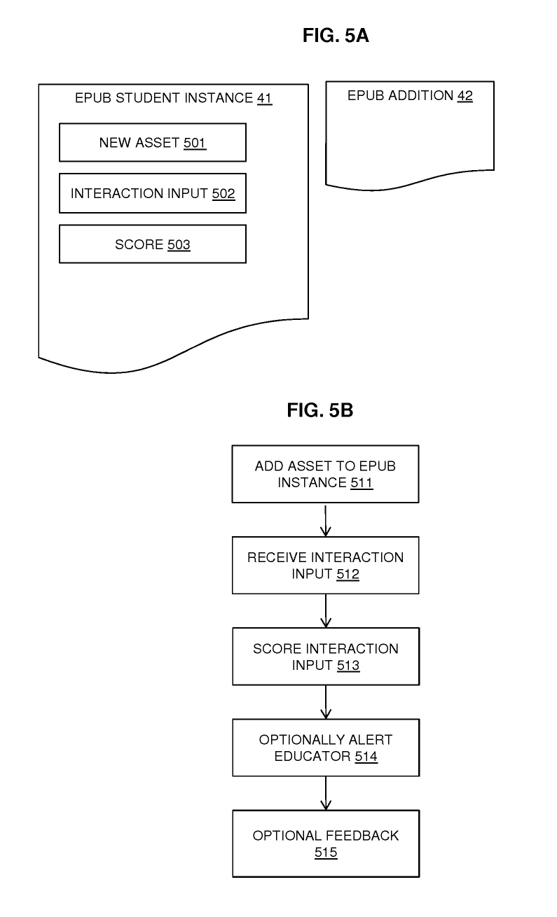

Referring to FIG. 5A, a schematic diagram shows an EPUB instant (41) of a student with EPUB additional content (42) provided including assets which provide assessments to the student.

The EPUB instance (41) may be updated with new assets (501) as described above and the student interactive input (502) may be recorded and a score (503) generated.

Referring to FIG. 5B, a flow diagram shows an example embodiment of this aspect of providing additional content for student assessment as carried out by the server (3).

An asset may be added (511) to an EPUB instance, for example on the fly and without recourse to external resources. Interactive input by the student is received (512) and scored (513) or otherwise assessed. Optionally, an educator alert or input may be activated (514) and optionally feedback may be provided (515) to the student and to the educator.

In implementing the fourth aspect of this invention a web-based audio-visual content creation tool comprises a student device and a computerized server side wherein the student side is displayed in a web browser with a large blank area (“canvas”). Command palettes, a screen toggle area, and control buttons are also provided to allow a student to choose operations selected from, or comprising, drawing lines, placing images, and erasing images in the blank area. The data generated is sent to the computerized server in pieces by the student device and reassembled by the server before storage.

The screen toggle area allows the student to create multiple virtual screens and move between them both before and during the recording. The control buttons allow the student to start, pause, and stop the recording at any time, as well as previewing the recording made so far, or cancelling it and starting over.

A timestamp is captured with each event to be used to synchronize audio data with the video data for playback with the audio replay determining the pace of the playback with video events being consumed as fast or as slow as required to keep pace with the audio playback.

The student side of the system uses an HTML5 canvas to capture video content, with an Adobe Flash component for capturing audio. The Flash component makes use of Adobe's Alchemy API to include a C++ component, which performs real-time transcoding of the audio data from the raw format captured by Flash, into the Ogg format. This format is much smaller (approximately 1/20th), and allows the data to be streamed to the computerized server directly, even on slower connections. The data is chunked into segments, each of which is transcoded independently, and then sent on to the computerized server as the recording continues. Thus, by the time the recording is finished, most of the data is already held by the server.

Video data is captured as a series of actions on the canvas. Each action the user makes is stored, forming a history of actions, which can be replayed from an arbitrary point, or modified as needed. This allows undo/redo operations to be implemented, as well as in-progress replays. The timestamp captured with each event is used to synchronize the audio with the video for playback. Thereafter, the audio replay determines the pace of the playback, and video events will be consumed as fast or as slow as required to keep pace with the audio replay.

The system is designed to create content that has a very low disk size footprint; can be rapidly created by even very modest server hardware, by leveraging the power of the student to perform the bulk of the work; can be created on students communications devices with relatively low outgoing bandwidth; and does not require post-processing to scale to a variety of resolutions for consumption, as well as being immediately available for use once complete.

The student can begin drawing on the canvas before starting the recording, to allow it to be pre-set up. The screen toggle area allows the student to create multiple virtual screens in the video, much like a presentation, and move between them at will, both before and during the recording. The control buttons allow the student to start, pause, and stop the recording at any time, as well as previewing the recording made so far, or cancelling it and starting over.

The server-side consists of a few services designed to receive data from the student, and store it. The data is sent to the server in pieces by the student communications device, and then reassembled by the server before storage. No additional processing is needed: the data is stored as-is, and is immediately ready for use by students.

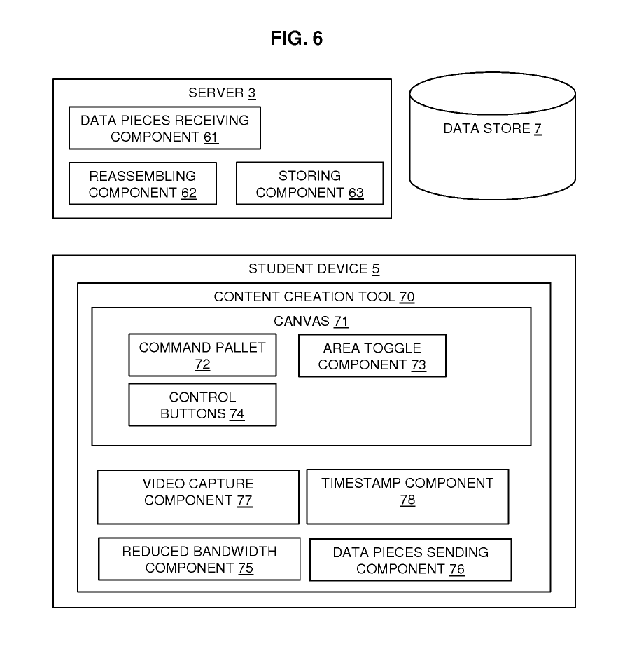

Referring to FIG. 6, a block diagram shows components of the educational infrastructure that provide the described fourth aspect.

A student device (5) is provided with a content creation tool (70) which includes a canvas (71) having user tools for inputting content such as a command palette (72), control buttons (74), and an area toggle component (73) as described above.

The content creation tool (70) may include a video capture component (77) and a timestamp component (78) for capturing timeslots of the user content of the canvas (71).

Data pieces of the generated content may be sent by a data pieces sending component (76) to a server (3) using a reduced bandwidth component (75).

The server (3) may include a data pieces receiving component (61), a reassembly component (62) and a storing component (63) for storing the reassembled pieces in a data store (7). The server (3) may receive and reassemble and store data for multiple student content providers.

It will be appreciated that different components of the various aspects and embodiments described may be used in combination with components of other aspects and embodiments.

It will be understood that an infrastructure set up according to the invention for the purpose of educators educating multiple students utilizing the infrastructure has considerable benefit over current education infrastructures.

Using an infrastructure as proposed by the present invention, educators are in full control of a class of students and form a pivotal role in the learning environment. They can push content and resources to the students' communications devices and conduct assessments and class tests via the personalized education framework that results from use of the infrastructure of the invention.

It is envisaged that educators may use EPUB books forming part of the official curriculum and add educational content in the form of various different items such as Word documents, PDF files, videos, text, website links and more to create a very much enhanced EPUB book. The EPUBs and added educational content are in turn synchronized and stored by the server against institutional and student profiles, thereby allowing complete recoverability in the event of data loss by students.

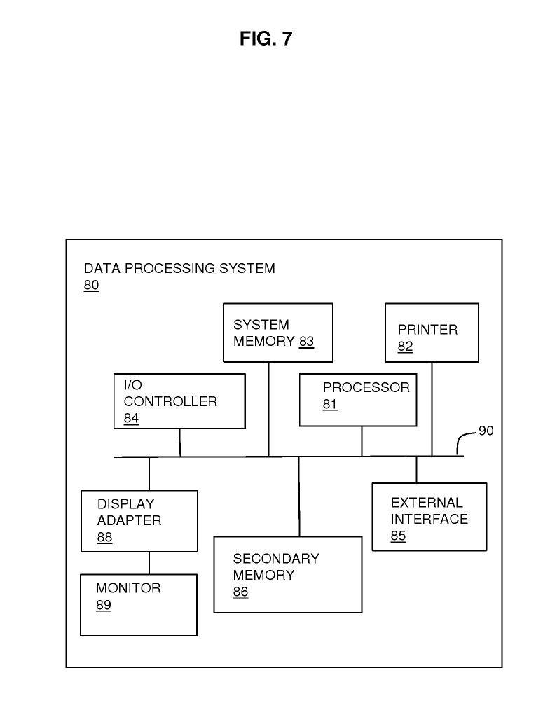

FIG. 7 illustrates an example of a data processing system (80) in which various aspects of the disclosure may be implemented. The data processing system (80) may be suitable for storing and executing computer program code. The various participants and elements in the previously described system diagrams may use any suitable number of subsystems or components of the data processing system (80) to facilitate the functions described herein.

The data processing system (80) may include subsystems or components interconnected via a communication infrastructure (90) (for example, a communications bus, a cross-over bar device, or a network). The data processing system (80) may include at least one central processor (81) and at least one memory component in the form of computer-readable media.

The memory components may include system memory (83), which may include read only memory (ROM) and random access memory (RAM). A basic input/output system (BIOS) may be stored in ROM. System software may be stored in the system memory (83) including operating system software.

The memory components may also include secondary memory (83). The secondary memory (83) may include a fixed disk, such as a hard disk drive, and, optionally, one or more removable-storage interfaces for removable-storage components.

The removable-storage interfaces may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces may also be in the form of ports or sockets for interfacing with other forms of removable-storage components such as a flash memory drive, external hard drive, or removable memory chip, etc.

The data processing system (80) may include an external communications interface (85) such as a network adapter for operation of the data processing system (80) in a networked environment enabling transfer of data between multiple data processing systems (80). Data transferred via the external communications interface (85) may be in the form of signals, which may be electronic, electromagnetic, optical, radio, or other types of signal.

The external communications interface (85) may enable communication of data between the data processing system (80) and other data processing systems including servers and external storage facilities. Web services may be accessible by the data processing system (80) via the communications interface.

The external communications interface (85) may also enable other forms of communication to and from the data processing system (80) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (81).

A computer program product may be provided by a non-transient computer-readable medium, or may be provided via a signal or other transient means via the external communications interface (85).

Interconnection via the communication infrastructure (90) allows a central processor (81) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the data processing system (80) either directly or via an I/O controller (84). These components may be connected to the data processing system (80) by any number of means known in the art, such as a serial port.

One or more monitors (89) may be coupled via a display or video adapter (88) to the data processing system (80).

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

It will also be understood that numerous variations may be made to the implementation of the various aspects of the invention as described above without departing from the scope thereof. Also, it is not necessary that all aspects of the invention be used in any one infrastructure. In particular, it is foreseen that any number of suitable communications devices may be used by students to access and interact with the infrastructure including, but not limited to, mobile phones, personal computers, personal digital assistants and other so-called “smart” devices to name but a few. The infrastructure provides a convenient platform whereby students may access and interact with their learning material from any number of suitable electronic devices, thereby drastically increasing the availability of learning material and also enhancing the learning and educating experience.

We claim:

1. An educational infrastructure comprising:
an educational institution having a real or virtual computerized server that is in operative communication with communications devices accessible to multiple students who are individually identifiable by way of identification data inputted from time to time by the individual students,
wherein the computerized server is programmed to monitor individual student activity on the relevant communications device whilst the student utilizes electronic learning material by way of the communications device, and;
wherein the computerized server is further programmed to record data as to the nature and duration of student engagement with electronic learning material of different types.

2. The educational infrastructure as claimed in claim 1, wherein the computerized server and communications devices operate on a cloud principle in which the computerized server retains at least the majority of software and electronic data used by the students including learning material in the form of electronic publications.

3. The educational infrastructure as claimed in claim 1, further comprising:
personalization of the learning material using push technology between the server and the communications device.

4. The educational infrastructure as claimed in claim 1, further comprising:
storing student provided content and annotations to the learning material.

5. The educational infrastructure as claimed in claim 1, further comprising:
enabling educator input from educator communication devices wherein the educator input relates to a particular student and includes input to learning material accessed by the student providing a unique student instance of the electronic learning material including student and educator content.

6. The educational infrastructure as claimed in claim 1, wherein the activity that is monitored comprises one or more of the group of:
the performance of the student in one or more of frequency of note taking, frequency of highlights being made to electronic learning material, frequency of exploring provided content pushed by teachers, frequency of own content added to electronic learning material or other electronic material, validity of content appended by a student related to current subject matter, quality of summaries generated by a student, frequency of opening, closing and duration of using a given electronic learning material; and for previous assessment information to be employed to identify problem areas of study.

7. The educational infrastructure as claimed in claim 1, further comprising:
monitoring student interaction with the electronic learning material;
creating a student profile based on the monitored interaction; and
scheduling assessments and input required based on the student profile.

8. The educational infrastructure as claimed in claim 1, further comprising:
inserting interactive assessments in the content of an electronic learning material on the fly that become part of the electronic learning material and require no linking to external applications or websites.

9. The educational infrastructure as claimed in claim 8, wherein the assessments are configured to test a student's knowledge about a section of the electronic learning material and meta-data is attached to questions and activities.

10. The educational infrastructure as claimed in claim 9, wherein scores are allocated to each question in order to assess a student's knowledge about different aspects of a subject and to provide a score, and for scores developed in such an operation to be sent to an educator for evaluation either immediately or at an appropriate later time.

11. The educational infrastructure as claimed in claim 1, further comprising:
synchronizing all content relating to the electronic learning including as originally published, created by the student, or created by the educator, on the server and stored in the data store in real time or periodically as and when access to the server is available, thereby enabling complete recovery of content by students and educators alike in the event of device malfunction, failure or switchover.

12. A method for providing personalized electronic learning material in an educational infrastructure, comprising:
providing access for a student to electronic learning material and referencing a student instance of the electronic learning material;
storing student provided content additions and annotations of the student instance of the electronic learning material;
pushing educator content into one or more specific student instances of the electronic learning material for storing in association with the student instance of the electronic learning material; and
providing a unique student instance of the electronic learning material including student and educator content.

13. An electronic publication (EPUB) summary of a full electronic publication, comprising:
a structure of the full electronic publication extracted and added to the summary, a plurality of phrases or passages or both in text of the full electronic publication which have been highlighted are extracted and added to the summary in a manner such that an assembly of the highlighted phrases and passages, together with any other information that is required, forms a summary of the full electronic publication.

14. The electronic publication summary as claimed in claim 13, further comprising:
extracting highlighting to be effected in combination with the identification of the start and of the end of a phrase or passage to form a three-part tuple identifying a start character and end character and a type of highlighting; for different phrases or passages to be highlighted differently for other purposes.

15. The electronic publication summary as claimed in claim 13, wherein the summary is further enriched with other relevant content added to the full electronic publication selected from images, videos, Uniform Resource Locator (URL) links, and other documents that can be attached at specific elements to enrich the existing content with additional information.

16. A web-based audio-visual content creation tool comprising:
a student side and a server side wherein the student side is displayed in a web browser with a large blank area (“canvas”), command palettes, a screen toggle area, and control buttons, wherein the command palettes allow the student to choose operations selected from, or comprising, drawing lines, placing images, and erasing images in the blank area and wherein the data is sent to the server in pieces by the student, and then reassembled by the server before storage.

17. The web-based audio-visual content creation tool as claimed in claim 16, wherein a format of the data results in a small file size and allows the data to be streamed to the server directly, even on slower connections, wherein the data is chunked into segments, each of which is transcoded independently, and then sent on to the server as the recording continues resulting in by the time the recording is finished, a substantial amount of the data is already held by the server.

18. The web-based audio-visual content creation tool as claimed in claim 16, wherein the screen toggle area allows the student to create multiple virtual screens and move between them both before and during the recording.

19. The web-based audio-visual content creation tool as claimed in claim 16, wherein the control buttons allow the student to start, pause, and stop the recording at any time, as well as previewing the recording made so far, or cancelling it and starting over.

20. The web-based audio-visual content creation tool as claimed in claim 16, wherein a timestamp captured with each event is used to synchronize audio data with video data for playback.
